(19) United States
(12) Patent Application Publication
(10) Pub. No.: US 2005/0001722 A1
(43) Pub. Date: Jan. 6, 2005

(54) Fuel dispenser ignition source detector

(76) Inventor: Lin Davis, Allen, MD (US)

Correspondence Address: FISH & RICHARDSON P.C., 5000 BANK ONE CENTER, 1717 MAIN STREET, DALLAS, TX, 75201, US

(21) Appl. No.: 10/613,720

(22) Filed: Jul. 3, 2003

(51) Int. Cl. G08B 21/00

(52) U.S. Cl. 340/540

(57) ABSTRACT

A source detector for use in a fuel dispensing station to make fuel filling impossible in the event of a fire, or the detection of an ignition source, or an open flame. The fuel dispensing station comprises at least one fuel dispenser and at least one source detector for generating a detection signal indicating an unwanted ignition source. Once the detection signal is generated, a control unit which receives the detection signal generates a control signal which is received by the fuel dispenser, wherein the fuel dispenser responds to the control signal by temporarily suspending fuel supply.

### TECHNICAL FIELD

This invention relates to fuel dispensers, and more particularly to fuel dispensers operating in the proximity of an ignition source detector.

### BACKGROUND

A conventional method of storing and dispensing fuel from a fuel dispensing station involves the use of underground storage tanks from which fuel is pumped, through a fuel dispenser, into the tanks of motor vehicles. This method of fuel dispensing is, however, subject to a number of drawbacks and disadvantages, one of which is the danger of fires or explosions when an open flame, spark or other ignition source is in the vicinity of the combustible fuel. Therefore, it is common for fuel stations to have signs which require users to turn off their vehicles and not light cigarettes in the area of fuel dispensing to prevent such hazards. Unfortunately, customers are injured from fires started by open flames, sparks, or other ignition sources in the vicinity of the combustible fuel as there is no way to detect the existence of such ignition sources.

Attempts have been made in the past to make fuel dispensing impossible in the event of a fire and preventing the combustible fuel from catching fire. This is achieved by equipping the fuel station with fire or smoke detectors which send a signal to shut off electric power supply to the fuel dispensers when a fire is detected. Unfortunately, the fire or smoke detectors do not detect sparks or other ignition sources and are prone to false alarm from heat and light. In another prior art technique, fuel dispensing is suspended by manually turning off the nozzle switches in case a fire is detected. However, this method does not account for an automatic detection of open flames, sparks or other ignition sources in the vicinity of the combustible fuel.

Therefore, what is needed is a method and system for automatically detecting an ignition source in the vicinity of the combustible fuel such that the detection will temporarily suspend fuel dispensing.

### SUMMARY

The present invention relates to controlling fuel dispensing in response to detection of unwanted ignition sources. According to the teachings of the present invention, an embodiment of the present invention is directed to a fuel dispensing station comprising at least one fuel dispenser. An ignition source detector is utilized for generating a detection signal indicating the presence of an unwanted ignition source in the vicinity of the fuel dispensing station. A control unit receives the detection signal and generates a control signal for output to the fuel dispenser, wherein the fuel dispenser then responds to the control signal by inhibiting the dispensing of fuel.

Advantages of this invention will become apparent from the following drawings and descriptions of the preferred embodiments.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic perspective view illustrating the structure of a fuel dispensing station according to an implementation of the present invention.

FIG. 2 is an illustration of a fuel dispenser according to an implementation of the present invention.

FIG. 3 is a block diagram illustrating signal transmission in the fuel-management system according to an implementation of the present invention.

FIG. 4 is a flow-diagram for illustrating the functions of a fuel-management unit for use in a fuel dispensing station according to an implementation of the present invention.

FIG. 5 is a flow-diagram for illustrating the functions of a fuel dispenser for use in a fuel dispensing station as a first implementation of the present invention.

FIG. 6 is a schematic view illustrating the structure of a fuel dispensing station according to a second implementation of the present invention.

FIG. 7 is a block diagram illustrating the structure of the fuel dispensing station according to a second implementation of the present invention.

Like reference symbols in the various drawings indicate like elements.

### DETAILED DESCRIPTION

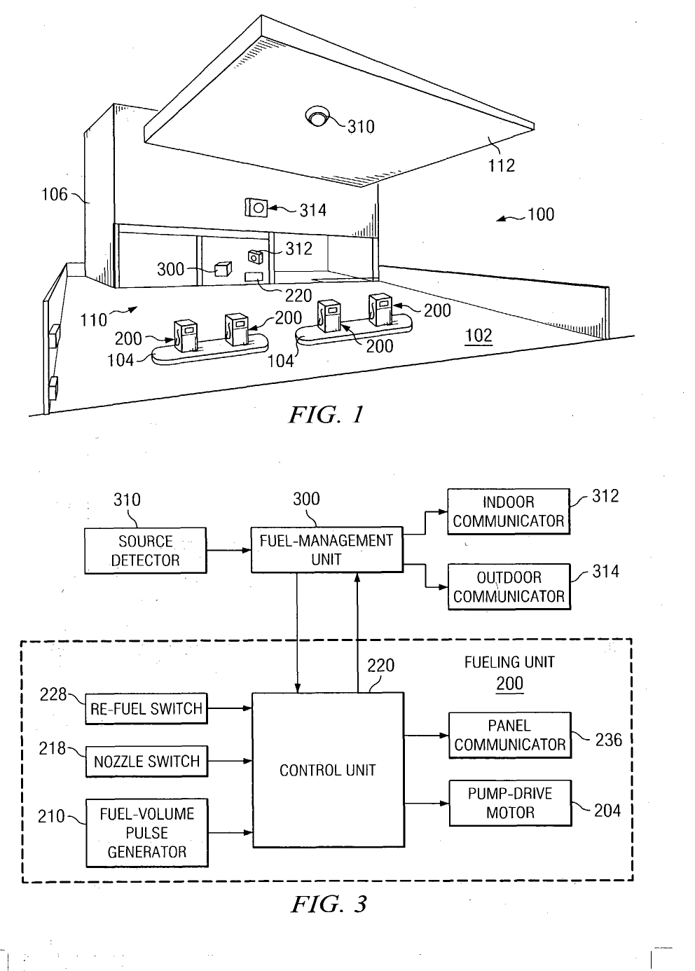

Referring generally to FIGS. 1-3, the fuel dispensing station 100 of the present invention comprises one or more fuel dispensers 200; at least one ignition source detector 310 for detecting unwanted ignition sources and one or more communicators 312, 314 for indicating ignition source detection by the ignition source detector 310.

An ignition source, such as a static discharge, self ignition, open flame, spark or embers can cause a fire or an explosion. The threat that a potential ignition source poses in the fuel dispensing station 100 depends upon the ignition source's size, location, temperature, energy content, length of life, and the maximum possible contact time between the ignition source and combustible material. Some ignition sources are produced by external means, such as cigarettes, welding, cutting and grinding. Other ignition sources are produced by internal means, such as friction between mechanically moving parts, wear or mechanical breakdown. Sparks and burning embers generated from normal manufacturing processes quite frequently provide ignition sources. Operations that are abrasive or grinding in nature, subjected to high temperatures, or involve metal on metal contact are particularly conducive to the generation of sparks. Spark generation is a constant danger in those locations where combustible materials are being worked, transported, dried, filtered or exhausted.

The ignition source detector 310 as utilized in the present invention is provided in a location where ignition sources can be detected. In one implementation, the ignition source detector 310 is positioned at the inner surface of the canopy or roof 112 of the fuel dispensing station 100, and preferably at a location providing a wide coverage, such as the center thereof. In another implementation, the ignition source detector 310 can be located at the outer surface of the fuel dispensers 200, preferably at the dispenser housing 202. The ignition source detector 310 can also be located near the fuel nozzle 214. In yet another implementation, the ignition source detector 310 can be provided internally within one or more of the fuel dispensers 200.

The ignition source detector 310 as utilized in the present invention refers to a device that generates a signal indicating detection of an unwanted ignition source and transmits the generated signal either directly to a control unit 220 or to the fuel-management unit 300. There are several sources of ignition and many techniques for sensing the presence of fires, open flames, etc. One of the most common and most unpredictable sources of ignition is static discharge, i.e. sparks. Static discharge by itself is not dangerous but poses a substantial risk of fire or explosion when generated near combustible fuel.

Several different ignition source detectors may be utilized in accordance with the present invention. As an exemplary implementation, a spark detector may be used to detect sparks and glowing embers. The radiant energy emitted from an ember is determined primarily by the ember fuel temperature and the emission properties of the ember fuel. Radiant energy from an ember is primarily infrared (IR) and to a lesser degree, visible in wavelength. In general, embers do not emit ultraviolet energy in significant quantities until the ember achieves temperatures of 3240° F. The spark detector as utilized in the present invention is capable of detecting even the smallest spark or hot particle in the vicinity of the combustible fuel, and initiate countermeasures instantaneously. The detection is accomplished by sensors recognizing the IR radiation of the sparks and glowing embers. The spark detector is also capable of detecting sparks through layers of dust or through conveyed dense material flow. Due to the wide variety and severity of applications, different types of sensors have been developed. Low temperature systems with ambient air temperatures less than 150° F. use a standard spark detector. For high temperature applications, the detecting sensor may be equipped with fiber optic cables. These fiber optic cable equipped sensors can detect sparks and embers in air stream temperatures between 150° F. and 1860° F. Special daylight sensors are also used in applications where ambient light is present. If a radiating spark or ember passes through the sensor's viewing area, the sensor will activate and generate a detection signal indicating an unwanted ignition source.

The ignition source detector 310, as used in the present invention, is suitable for installation in high ambient temperatures or where daylight temperature penetrates the installation location. Besides spark detection, the ignition source detector 310 may also be capable of detecting smoke or open flames. As an exemplary implementation, a flame detector may be used to detect an open flame. A flame detector is a radiant energy-sensing fire detector that detects the radiant energy emitted by a flame. Flame detectors are categorized as ultraviolet, single wavelength infrared, ultraviolet infrared, or multiple wavelength infrared. The radiant energy from a flame is comprised of emissions in various bands of the ultraviolet, visible, and infrared portions of the spectrum. The relative quantities of radiation emitted in each part of the spectrum are determined by fuel chemistry, temperature, and rate of combustion. Thus, the ignition source detector to be used should resemble the characteristics of the flame to be detected.

Several different ignition source detectors 310 may be utilized in accordance with the present invention. In yet another exemplary implementation, an infrared (IR) detector may be used that responds immediately to the thermal infrared radiation emitted by fire, and is tuned to the pulse frequency of the flame to ignore sun, lamps and other light and IR radiation sources. Sun and lamps also generate thermal IR radiation, however, flame is different as it flickers at a particular frequency. The IR detector is tuned to this pulsing radiation to ignore sun, lamp or other light sources to avoid false detections. Moreover, the ignition source detectors used in the present invention respond to the flicker of spark or flame, whereby radiant heat is ignored.

It is preferable that the fuel dispensing station 100 of the present invention further comprise a fuel-management unit 300. The fuel-management unit 300 as utilized in the present invention refers to a unit that receives control signals from the control unit 220 when an ignition source has been detected by the ignition source detector 310. The fuel-management unit 300 transmits a detection signal to the communicators 312, 314 which signal the detection. The communicators 312, 314 as used in the present invention can be provided in the fuel dispensing station 100, for instance on the fuel dispenser 200, in the office within the fuel dispensing station 100, in the public area in the fuel dispensing station 100, and at a location remote from the fuel dispensing station 100. Additionally, the fuel-management unit 300 also controls the amount of fuel being dispensed.

When an ignition source is detected by the ignition source detector 310, the fuel-management unit 300 transmits a detection signal to the communicators 312, 314 which indicate the detection. The fuel-management unit 300 sends a message on the display screen 234 of the fuel dispenser 200 informing the customers that an ignition source has been detected and that fuel supply will temporarily be suspended. Additionally, the communicators 312, 314 provide the same or similar information to customers and employees within an office building or a public area (such as a convenience store). It is possible in the present invention to use communicators 312, 314 which indicate the detection of an ignition source by means of light, sound or both.

Moreover, the fuel dispensers 200 of the present invention preferably comprise a control unit 220 which may reside within each of the fuel dispensers 200. The control unit 220 is connected to a fuel-management unit 300 for signal transmissions therebetween. The control unit transmits a signal relating to fuel volume to the fuel-management unit 300. Fueling is suspended by the fuel dispenser 200 upon receipt of a control signal output from the control unit 220 in response to receipt of the detection signal generated by the fuel-management unit 300. In an alternate implementation, the detection signal is transmitted directly from the ignition source detectors 310 provided in each of the fuel dispensers 200.

Other features of this invention will become apparent in the course of the following description of the exemplary implementations and are not intended to be limiting thereof.

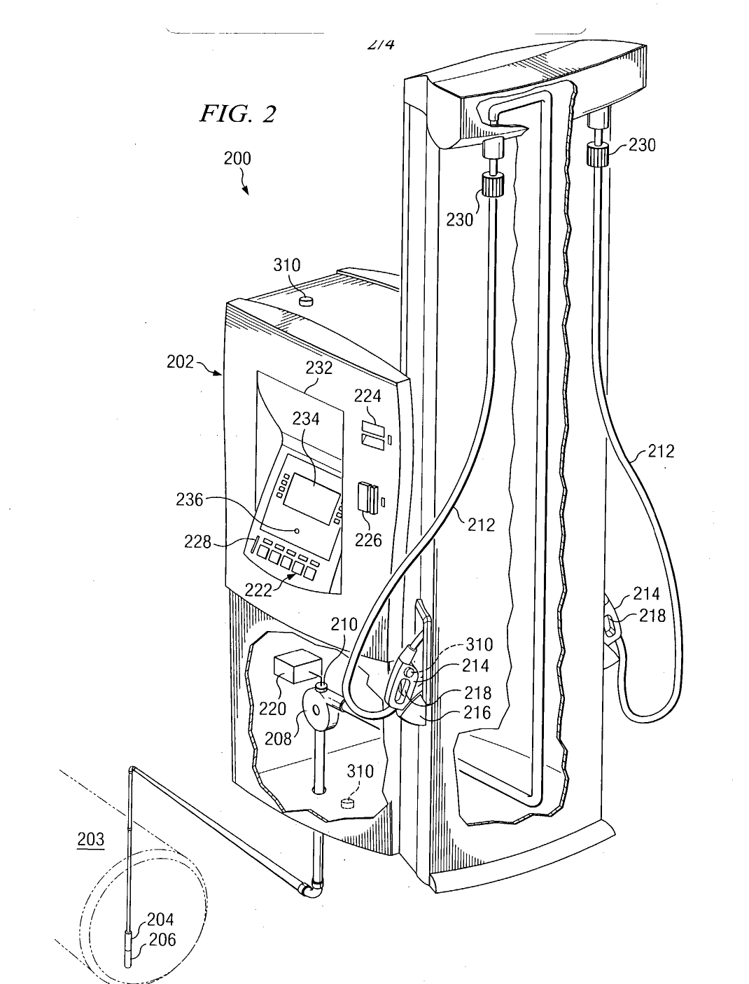

With reference to FIG. 1 of the drawings, the reference numeral 100 refers, in general, to a fuel dispensing station. On site 102 of the fuel dispensing station 100, there are islands 104 on each of which one or more fuel dispensers 200 are provided. On the rear part of site 102, an office building 106 is located within which an indoor communicator 312 and a fuel-management unit 300 are provided. Additionally, the office building 106 in some cases may include a public area, for example, a convenience store. An outdoor communicator 314 is provided on the outside wall of the office building 106 in such a way that the communicator 314 can be seen from almost all parts of the site 102. A canopy 112 covers much of the site 102. An ignition source detector 310 is provided on the lower surface of the canopy 112 for detecting the presence of an ignition source within the vicinity of the fuel dispensing station 100. In an alternate implementation, the ignition source detector 310 is located on the dispenser housing 202 (FIG. 2) of the fuel dispensing unit 200 or near the fuel nozzle 214 (FIG. 2). In yet another implementation, the ignition source detector 310 is located internally within the fuel dispenser 200 (FIG. 2).

FIG. 2 shows a schematic diagram of the fuel dispenser 200 to be used in the fuel dispensing station 100. The dispenser housing 202 is connected to an underground storage tank 203 which uses fuel pump 206 which is driven by means of pump-drive-motor 204. The dispenser housing 202 contains flow meter 208 with flow-volume-pulse generator 2 1 0 thereon, being successively connected on fueling pipes to the underground tanks. Furthermore, the fueling pipe connected to the outlet of the flow meter 208 leads to the outside of the dispenser housing 202 for connection to fueling hose 212 and fuel nozzle 214. Nozzle rest 216 is provided on the dispenser housing 202 for hanging the fuel nozzle 214, with nozzle switch 218 being arranged nearby the nozzle rest 216.

A control unit 220 is provided within the dispenser housing 202, which controls the actuation of the pump-drive-motors 204 in response to signals from a fuel-management unit 300 (FIG. 1). The control unit 220 also controls the indication onto a display screen 234 of the volume of fuel dispensed.

There is provided an operational panel 232 on the front surface of the dispenser housing 202. The operational panel 232 contains thereon a keyboard 222 for selecting the fuel type and fuel volume, a panel communicator 236 for indicating information obtained from the fuel-management unit 300 via the control unit 220, a printer 224 for issuing a receipt, a card reader 226, a display screen 234 and a re-fuel switch 228 for restarting fueling after fuel flow has been temporarily suspended.

In an alternate implementation, the control unit 220 can be placed outside the dispenser housing 202 and in an office 106 within the fuel dispensing station 100.

Referring now to FIG. 3, the control unit 220 and the fuel-management unit 300 are connected to each other for signal transmission therebetween. The control unit 220 transmits a signal relating to fuel volume to the fuel-management unit 300. On the other hand, the fuel-management unit 300 transmits a signal to the control unit 220 for controlling the operation of the fuel dispenser 200.

The fuel-management unit 300 for use in the present invention receives signals from the fuel dispenser 200 and transmits the detection signal to the pump-drive-motor 204 to have the pump 204, 206 stop and start. Additionally, the fuel-management unit 300 also outputs signals for controlling the indoor and outdoor communicators 312 and 314.

The control unit 220 further receives signals from the re-fuel switch 228, nozzle switch 218, and fuel-volume-pulse generator 210, and outputs signals to the panel communicator 236 and pump drive motor 204.

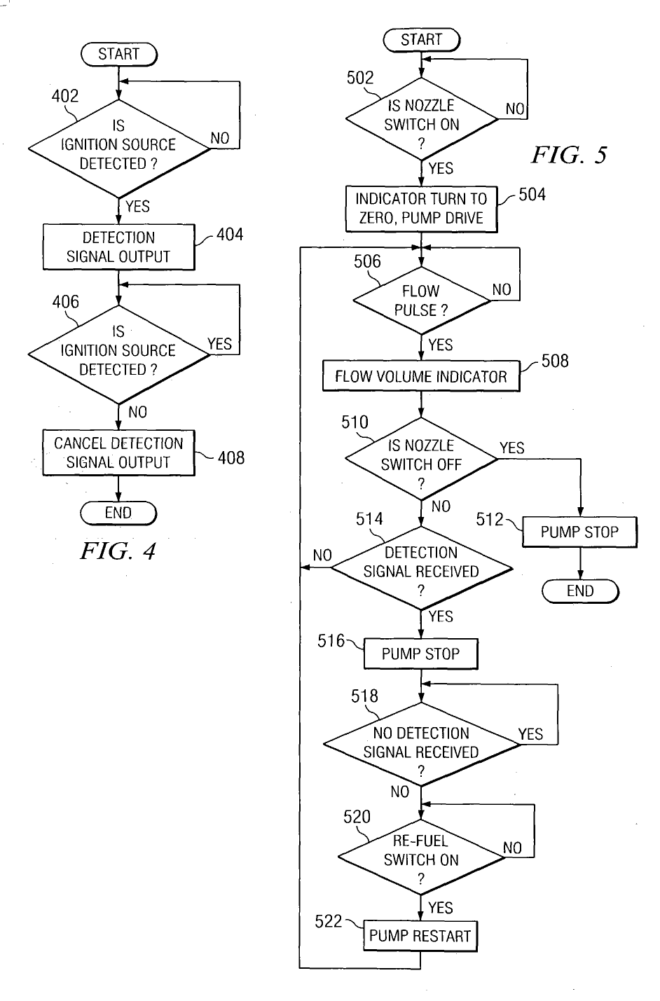

FIG. 4 is a flow chart illustrating the function of the fuel-management unit 300 for use in the present invention. The ignition source detector 310 operates in a loop to check for detection of an unwanted ignition source (Step 402). At Step 404, if an ignition source is detected, the fuel-management unit 300 transmits a detection signal to the indoor and outdoor communicators 312 and 314, and simultaneously transmits the detection signal to each of the fuel dispensers 200, to make indication on the display screen 234 and panel communicator 236 provided on each of the fuel dispensers 200 and prohibits the dispensing of fuel. The output of the detection signal is maintained until the ignition source is no longer detected by the source detector 310 (see, loop step 406). When the ignition source is no longer detected, the fuel-management unit 300 ceases output of the detection signal (step 408) and may stop the communication made by the indoor and outdoor communicators 312 and 314, whereby indication on the display screen 234 and panel communicator 236 may be canceled, enabling the resumption of dispensing of fuel.

FIG. 5 illustrates a flow diagram describing the function of the fuel dispensers 200 for use in the present invention. When a fueling nozzle 214 is detached from the nozzle rest 216 and the nozzle switch 218 is turned on (Step 502), the pump-drive-motor 204 is activated (Step 504). Step 502 may also include the selection of fuel type or grade, or some other overt action by the consumer to initiate refueling. Subsequently, when the fuel lever is pulled up upon the fueling nozzle 214 being inserted to the fuel tank of a vehicle, fuel is dispensed into the tank using the fuel pump 206. A flow-volume-pulse signal is output from the flow-volume-pulse-generator 210 (Step 506) and the volume of fuel dispensed is indicated on the display screen 234 of the operational panel 232 after the flow-volume pulse is integrated (Step 508). With the completion of fueling, the nozzle switch 218 is turned off (Step 510), activation of the pump-drive motor 204 is stopped and the fuel pump 206 is stopped (Step 512).

In the case where a detection signal from the source detector 310 is received by the fuel-management unit 300 (Step 514), the control unit 220 causes actuation of the pump-drive-motor 204 to stop and causes the fuel dispensers to temporarily suspend fuel supply (Step 516). Additionally, the control unit 220 may further deactivate the vapor recovery device. The suspended actuation state of the pump-drive-motor 204 is maintained as long as the detection signal continues to be output from the fuel-management unit 300 due to the detection of an ignition source by the ignition source detector 310. When the ignition source detector 310 no longer detects an unwanted ignition source, the detection signal output from the fuel-management unit 300 is canceled (Step 518) and the re-fuel switch 228 may be turned on (Step 520). When the detection signal is canceled (Step 518) and the re-fuel switch 228 is formed on the pump-drive-motor 204 may restart (Step 522). In an alternative implementation. Step 522 may require affirmative action by a station attendant who can visually confirm that the ignition source no longer exists. This prevents shielding of a source, such as a cigarette, by the consumer in order to trick the sensors into reporting no ignition source exists. Thus, the system returns to Step 506 where the flow-volume pulse is continued and fuel is dispensed.

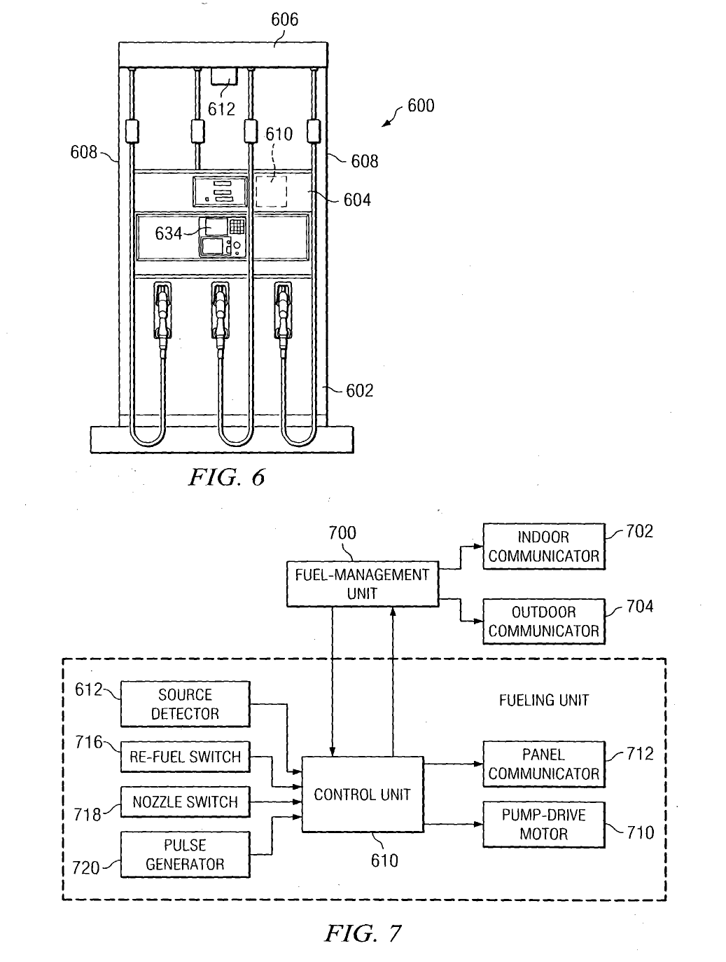

Referring now to FIGS. 6-7, another implementation of the fuel dispensing station in accordance with the present invention includes a plurality of fuel dispensers 600, as shown by the front view of FIG. 6, installed in the fuel dispensing station as shown generally in FIG. 1.

The fuel dispenser 600 dispenses various qualities of fuel such as premium, regular, and diesel. The fuel dispenser 600 comprises a dispenser housing 602, an indicator housing 604 placed thereon, and a top part housing 606 over the indication housing 604 supported by posts 608. The fuel dispenser is constructed substantially in the same way as in FIG. 1.

In this implementation, signal transmission is performed by way of a control unit 610, contained in the indicator housing 604. Moreover, source detector 612 is placed on the top housing 606 at the lower surface thereof. In an alternate embodiment, the source detector can be placed on the canopy on the inner surface thereof. In another implementation, the source detector can be placed near the fuel nozzle or placed internally within the fuel dispenser 600.

FIG. 7 is a block diagram illustrating the signal transmission in the fuel dispenser 600. The signal detected by the source detector 612 is transferred to the control unit 610. The control unit 610 which has received the detection signal causes the pump-drive-motor to stop operating.

The control unit 610 is connected to a fuel-management unit 700 which is provided in an office building as discussed earlier with regard to the earlier implementation of the present invention. The detection signal is transmitted between the control unit 610 and the fuel-management unit 700. The fuel-management unit 700 transmits signals to an indoor communicator 702 and an outdoor communicator 704. The communicators 702, 704 indicate the detection as described in the earlier implementation.

In the fuel dispensing station described in this implementation according to the present invention, the signal transmission is performed essentially in the same way as in the implementation explained with reference to FIGS. 4 and 5.

However, in the implementation of FIG. 6, the source detector 612 may be provided in each of the fuel dispensers 600. When the source detector 612 detects an ignition source within the vicinity of the fuel dispensing station, the control unit 610 directly controls the pump-drive-motor 710 to suspend fueling, causes the panel communicator 712 to show the detection, and transmits the detection signal to the fuel-management unit 700. The fuel-management unit 700 controls the indoor and outdoor communicators 702 and 704, respectively.

Moreover, when the source detector 612 no longer detects an ignition source, the signals shown by the panel communicators 712 are cancelled. Fueling is then started again when the re-fuel switch 716 is turned on. In this case, the fuel-management unit 700 outputs a signal for turning off the indoor and outdoor communicators 702 and 704 upon receipt of the non-detection signal transmitted from the control unit 610.

In the above implementations, it is possible to suspend fueling when the source detector detects an ignition source without showing any indication by the communicators. In the present invention, it is possible to use other types of fuel dispensers which can dispense several types of fuel. In an alternate implementation, it is possible to provide a system wherein the ignition source detected by the source detector 612 which is placed outside the fuel dispensers 600 is directly transmitted to the control unit 610.

It is understood that variations may be made in the foregoing without departing from the scope of the invention. Although embodiments of the fuel dispensing stations have been illustrated in the accompanying drawings and described in the foregoing detailed description, it will be understood that the invention is not limited to the embodiments disclosed, but it is capable of numerous rearrangements, modifications and substitutions as may be included in the spirit and scope of the invention as defined in the following claims.

A number of embodiments of the invention have been described. Nevertheless, it will be understood that various modifications may be made without departing from the spirit and scope of the invention. For example, the system may activate or direct surveilance equipment on the premise to record the ignition source detected. Accordingly, other embodiments are within the scope of the following claims.

1. A fuel dispensing station comprising:
at least one fuel dispenser;
an ignition source detector for generating and transmitting a detection signal indicating the presence of an unwanted ignition source; and
a control unit which receives said detection signal and generates a control signal for output to said fuel dispenser, wherein said fuel dispenser responds to said control signal by inhibiting the dispensing of fuel.

2. The fuel dispensing station of claim 1, further comprising:
a fuel-management unit and at least one communicator, wherein said detection signal output by said source detector is received by a fuel-management unit, the fuel-management unit outputting an information signal to the communicator to inform users that fuel dispensing has been suspended.

3. The fuel dispensing station of claim 2, wherein said fuel dispenser includes said control unit therein, and wherein said detection signal generated when said ignition source is detected is transmitted to said control unit via said fuel-management unit.

4. The fuel dispensing station of claim 1, wherein said source detector is provided on a canopy over said fuel dispensing station.

5. The fuel dispensing station of claim 1, wherein said source detector is provided on a dispenser housing of said fuel dispenser.

6. The fuel dispensing station of claim 1, wherein said source detector is provided internally within said fuel dispenser.

7. The fuel dispensing station of claim 1, wherein said source detector is provided on a fuel nozzle.

8. The fuel dispensing station of claim 1, wherein said unwanted ignition source comprises a spark, an open flame, or embers.

9. The fuel dispensing station of claim 1, wherein said fuel dispenser responds to said control signal by temporarily suspending fuel supply.

10. The fuel dispensing station of claim 1, wherein at least one communicator outputs signals by means of light, sound or both.

11. The fuel dispensing station of claim 1, wherein said source detector is an Infrared (IR) detector.

12. The fuel dispensing station of claim 1, wherein said source detector is an electromagnetic spectrum detector.

13. A fuel dispensing station comprising:
at least one fuel dispenser;
an ignition source detector provided internally within said fuel dispenser for generating a detection signal indicating an unwanted ignition source;
a fuel-management unit for transmitting said detection signal detected by said source detector to at least one communicator; and
a control unit which receives said detection signal and generates a control signal for output to said fuel dispenser, wherein said fuel dispenser responds to said control signal by inhibiting the dispensing of fuel.

14. A method for preventing unintended ignition in a fuel dispensing environment comprising the steps of:
detecting an ignition source;
communicating the detection of an ignition source to at least one of a customer, an onsite personnel, and an offsite personnel; and
suspending the delivery of fuel in reaction to the detection of the ignition source.

15. The method of claim 14 wherein the detecting includes detecting at least one of a spark, an ember, and a flame.

16. The method of claim 14 wherein the communicating includes the use of light or sound.

17. The method of claim 14 wherein the suspending includes suspending operation of pumps in the dispensing environment.

18. The method of claim 14 further including the steps of:
detecting the absence of an ignition source; and
resuming the delivery of fuel in reaction to the detection of the absence of an ignition source.

19. The method of claim 14 further comprising the steps of:
detecting the absence of an ignition source;
communicating the absence of an ignition source to at least one of a customer, an onsite personnel, and an offsite personnel; and
allowing the resumption of fuel dispensing if requested by at least on of a customer, an onsite personnel, and an offsite personnel.

20. The method of claim 19 further comprising the step of allowing resumption of fuel dispensing only upon request by onsite personnel.

21. The method of claim 14 further comprising the steps of:
generating a detection signal upon detecting an ignition source;
transmitting the detection signal to a control unit;
generating a control signal in reaction to receipt of the detection signal at the control unit; and
transmitting the control signal to at least one of a communicator and a fuel delivery system.

22. A system for dispensing fuel comprising:
an ignition source detector which generates and transmits a detection signal upon detecting at least one of a spark, an ember and a flame;
a fuel dispenser for delivery of fuel into containers or vehicles;
a communicator for communicating with either sound or light to at least one of a customer in the vicinity of the fuel dispenser, an onsite personnel, and an offsite personnel; and
a control unit operably connected with the ignition source detector, fuel dispenser, and communicator and adapted to receive the detection signal transmitted by the ignition source detector and in reaction to the detection signal generate and transmit at least one control signal;
wherein the fuel dispenser receives the control signal and suspends the delivery of fuel and the communicator receives the control signal and communicates the detection of an ignition source.
